(19) United States
(12) Patent Application Publication
(10) Pub. No.: US 2020/0102935 A1
(43) Pub. Date: Apr. 2, 2020

(54) Renewable Energy Source with Energy Storage Device

(71) Applicant: General Electric Renovables España, S.L., Barcelona (ES)

(72) Inventors: Andreu Casal Vilana, Barcelona (ES); Veena Padmarao, Bangalore (IN); Igor Berroteran Gil, Salem, VA (US)

(21) Appl. No.: 16/585,050

(22) Filed: Sep. 27, 2019

(30) Foreign Application Priority Data
Sep. 27, 2018 (IN) 201841036543

(51) Int. Cl. F03D 9/11; F03D 9/25; H02J 3/38

(52) U.S. Cl. CPC F03D 9/11; H02J 3/386; F03D 9/255

(57) ABSTRACT

A system comprising: a renewable power source (1) with a renewable power generator and a controller (40) for controlling the renewable power source, a power converter (30) electrically coupled with the renewable power generator and configured to connect the renewable power generator with an electrical grid, and the power converter comprising a DC link (31), and an energy storage device (50) configured to be electrically coupled with the DC link. The controller is configured to receive a signal from the energy storage device (50) and transmit this signal from the energy storage device to the power converter (30). Further disclosed are methods for connecting a DC link (31) of a power converter (30) with an energy storage device (50) and methods for transmitting information between a power converter (30) coupled to a generator of a turbine and an energy storage device (50).

The present disclosure relates to systems including a renewable power source and an energy storage device, and particularly to wind turbines combined with energy storage device. The present disclosure further relates to methods for connecting a DC link of a power converter with an energy storage device and to methods and systems for transmitting information between a power converter coupled to a generator of a turbine and an energy storage device.

### BACKGROUND

Renewable energy, such as wind and solar energy receive increasing attention from the public at large to deliver electrical power to the electrical grid.

Modern wind turbines for example are commonly used to supply electricity into the electrical grid. Wind turbines of this kind generally comprise a tower and a rotor arranged on the tower. The rotor, which typically comprises a hub and a plurality of blades, is set into rotation under the influence of the wind on the blades. Said rotation generates a torque that is normally transmitted through a rotor shaft to a generator, either directly (“directly driven”) or through the use of a gearbox. This way, the generator produces electricity which can be supplied to the electrical grid.

Wind turbines and other power sources may be connected to the electrical grid through a power converter which adapts the generated power to the electrical grid and may also provide electricity to the (wind turbine) generator and to an extent control the generator, particularly the generator torque. The electrical power generated by the generator may not be adapted to the electrical grid e.g. in terms of phase angle and frequency. The power converter may be configured to convert the power generated in the generator to electrical power that can be delivered to the grid.

Different topologies for power converters are known and they may be adapted to the generator topology used. For example, power converters including a machine side rectifier (AC/DC), coupled in series by a DC link to a grid side inverter (DC/AC) are known.

Renewable energy sources, such as wind turbines, water turbines and e.g. solar panels are reliant on an inherently variable energy supply. Therefore, throughout the day, and throughout the year, there can be a (temporary) mismatch between the electrical power demand from households and industry and the electrical power supply from renewable (and non-renewable) energy sources. Such a mismatch may lead to problems in the electrical grid, e.g. grid frequency problems. In order to reduce such a mismatch, it is known to use energy storage device systems in conjunction with renewable power generators. When the renewable power generator is generating a surplus of power, the energy may be stored in the energy storage device. The energy that is stored may be used at a later stage to cover electrical power demand when there is not enough electrical power supply from energy sources.

It is known e.g. to electrically couple a battery or a battery string to a DC link of the power converter. The power converter arranged between the renewable power generator and the electrical grid can, dependent on electrical grid demands, and dependent on renewable power supply control the converter to divert DC power to the energy storage device, or to divert DC power from the energy storage device to the DC link.

After the DC link has been decoupled from the energy storage device, e.g. in the case that the renewable power generator is not operating, it is important to properly reconnect the energy storage device to the DC link. In particular, it is desirable for the voltage level of the energy storage device to be substantially the same as the voltage level of the DC link at the moment of connecting. Otherwise electrical components may be damaged due to high inrush currents at the moment of connection.

### SUMMARY

In one aspect, a system is provided comprising a renewable power source with a renewable power generator and a controller for controlling the renewable power source. The system further comprises a power converter electrically coupled with the renewable power generator and configured to connect the renewable power generator with an electrical grid, and the power converter comprising a DC link. And the system also comprises an energy storage device configured to be electrically coupled with the DC link. The controller is configured to receive a signal from the energy storage device and transmit the signal from the energy storage device to the power converter.

In this aspect, a system is provided in which a signal from an energy storage device can be transmitted to the power converter even if the energy storage device and the power converter cannot directly communicate with each other. Such a direct communication may not be possible due to e.g. incompatible communication protocols, or to a temporary interruption of communication due to a fault. The system resolves such a problem by re-directing the communication through the controller of the renewable power source.

In another aspect, a method for connecting a DC link of a power converter with an energy storage device is provided. The method comprises the power converter receiving a voltage level of the energy storage device and operating the power converter such that a DC link voltage reaches the voltage level of the energy storage device. The DC link is connected to the energy storage device when the DC link voltage substantially corresponds to the voltage level of the energy storage device. Herein, receiving the voltage level of the energy storage device comprises a controller of a renewable power source electrically coupled to the power converter receiving the voltage level of the energy storage device, and the controller transmitting the voltage level of the energy storage device to the power converter.

According to this aspect, the DC link can be connected at the correct moment when the voltage level of the energy storage device substantially corresponds to a voltage level of the DC link by ensuring communication between the power converter and the energy storage device.

In yet a further aspect, a method for transmitting information between a power converter coupled to a generator of a turbine and an energy storage device is provided. The method comprises: the energy storage device transmitting a first information to a controller of the turbine, and the controller of the turbine transmitting the first information to the power converter.

### BRIEF DESCRIPTION OF THE DRAWINGS

Non-limiting examples of the present disclosure will be described in the following, with reference to the appended drawings, in which:

FIG. 1 illustrates a perspective view of a wind turbine according to one example;

FIG. 2 illustrates a simplified, internal view of a nacelle of a wind turbine according to one example; and

FIG. 3 illustrates an example of a system according to the present disclosure;

FIG. 4 is a flow diagram of a method for connecting a DC link of a power converter with an energy storage device according to one example; and

FIG. 5 is a flow diagram of a method for transmitting information between a power converter coupled to a generator of a turbine and an energy storage device according to one example.

### DETAILED DESCRIPTION OF EXAMPLES

In these figures the same reference signs have been used to designate matching elements.

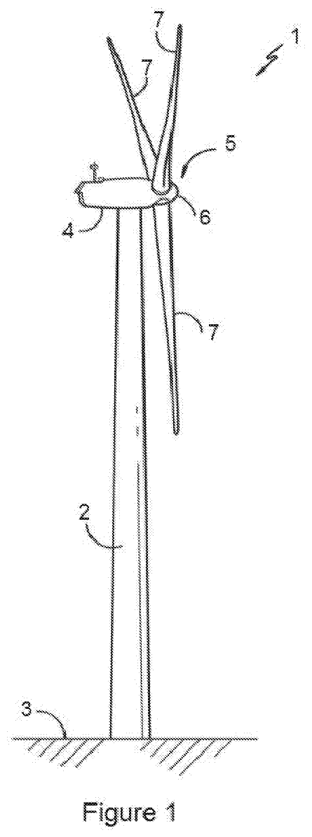

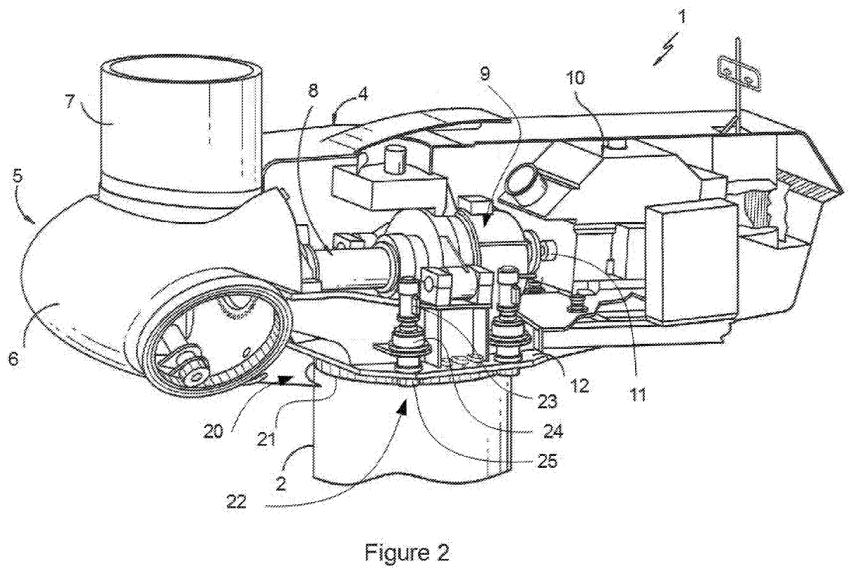

FIG. 1 illustrates a perspective view of one example of a wind turbine 1. As shown, the wind turbine 1 includes a tower 2 extending from a support surface 3, a nacelle 4 mounted on the tower 2, and a rotor 5 coupled to the nacelle 4. The rotor 5 includes a rotatable hub 6 and at least one rotor blade 7 coupled to and extending outwardly from the hub 6. For example, in the illustrated example, the rotor 5 includes three rotor blades 7. However, in an alternative embodiment, the rotor 5 may include more or less than three rotor blades 7. Each rotor blade 7 may be spaced from the hub 6 to facilitate rotating the rotor 5 to enable kinetic energy to be transferred from the wind into usable mechanical energy, and subsequently, electrical energy. For instance, the hub 6 may be rotatably coupled to an electric generator 10 (FIG. 2) positioned within the nacelle 4 or forming part of the nacelle to permit electrical energy to be produced.

FIG. 2 illustrates a simplified, internal view of one example of the nacelle 4 of the wind turbine 1 of the FIG. 1. As shown, the generator 10 may be disposed within the nacelle 4. In general, the generator 10 may be coupled to the rotor 5 of the wind turbine 1 for generating electrical power from the rotational energy generated by the rotor 5. For example, the rotor 5 may include a main rotor shaft 8 coupled to the hub 5 for rotation therewith. The generator 10 may then be coupled to the rotor shaft 8 such that rotation of the rotor shaft 8 drives the generator 10. For instance, in the illustrated embodiment, the generator 10 includes a generator shaft 11 rotatably coupled to the rotor shaft 8 through a gearbox 9.

It should be appreciated that the rotor shaft 8, gearbox 9, and generator 10 may generally be supported within the nacelle 4 by a bedplate or a support frame 12 positioned atop the wind turbine tower 2.

The nacelle 4 is rotatably coupled to the tower 2 through a yaw system 20. The yaw system comprises a yaw bearing (not visible in FIG. 2) having two bearing components configured to rotate with respect to the other. The tower 2 is coupled to one of the bearing components and the bedplate or support frame 12 of the nacelle 4 is coupled to the other bearing component. The yaw system 20 comprises an annular gear 21 and a plurality of yaw drives 22 with a motor 23, a gearbox 24 and a pinion 25 for meshing with the annular gear for rotating one of the bearing components with respect to the other.

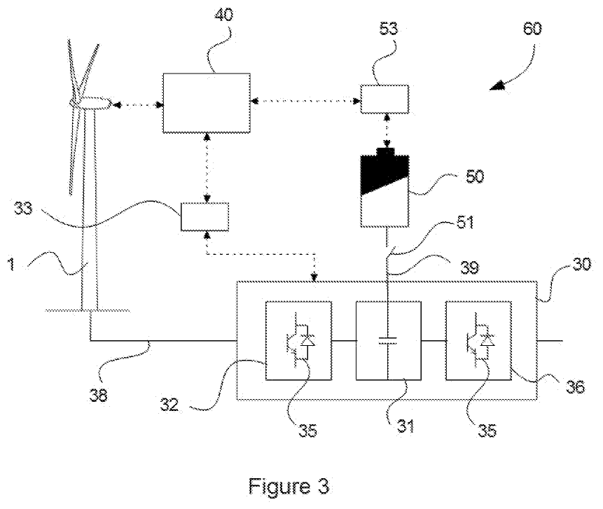

FIG. 3 illustrates an example of a system according to the present disclosure.

FIG. 3 illustrates a system 60 comprising a renewable power source 1 with a renewable power generator (not visible in FIG. 3) and a controller 40 for controlling the renewable power source 1. A power converter 30 is electrically coupled with the renewable power generator and configured to connect the renewable power generator with an electrical grid. In this particular example, the renewable power source is a wind turbine including a wind turbine generator. In other examples, the renewable power source may be e.g. a plurality of solar panels, or a hydrokinetic machine such as a water turbine.

As illustrated in FIG. 3, the power converter 30 comprises a DC link 31, and the system 60 further comprises an energy storage device 50 configured to be electrically coupled with the DC link 31. In this particular example, a string of batteries may be used as energy storage device 50. For reasons of simplicity, the energy storage device 50 is herein depicted as a single battery.

As illustrated in FIG. 3, the controller 40 is configured to receive a signal from the energy storage device 50 and transmit the signal from the energy storage device 50 to the power converter 30.

The signal from the energy storage device may indicate a voltage level of the energy storage device. Alternatively or additionally, the signal may indicate several parameters of the energy storage device as for example a current, a temperature, diagnosis of the energy storage device (e.g. alarms, status, . . . ) and charge level of the energy storage device.

The batteries may comprise one or more switches 51 to electrically connect with the DC link 31. In normal operation, the generator will be electrically connected through power cables 38 to the power converter. Also the batteries will be electrically connected to the power converter through power cables 39. Through this electrical connection, the power converter can measure directly or indirectly several parameters of the energy storage device, including e.g. a voltage level, storage or charge level etc. These parameters may also be measured or determined by an energy storage device control system 53. An energy storage device control system 53 may herein be understood as referring to a circuit or one or more processor(s) and associated memory device(s) configured to perform a variety of control functions of the energy storage device.

If the DC link 31 and the batteries are not electrically connected (i.e. the switches 51 are open), e.g. during downtime of the wind turbine, the converter cannot directly or indirectly measure the parameters of the energy storage device, e.g. the voltage level of the batteries. Depending on the configuration of the energy storage device 50 and the configuration of the power converter 30, direct communication between these two entities may not be possible. For example, the energy storage device may use a communication protocol that is unsuitable for the power converter.

The wind turbine controller 40 may for this purpose be configured to receive a voltage level of the energy storage device 50 and transmit the voltage level of the energy storage device to the power converter 30. By transmitting the voltage level to the converter, the converter can be operated so as to achieve a suitable voltage level in the DC link 31. This may be called a pre-charge sequence. Once this suitable voltage level is attained, the switches 51 may be closed and the energy storage device 50 may be connected to the DC link 31. As long as the electrical connection is operative, there might not be a need for extensive communication of energy storage device parameters to the power converter. Through the electrical connection, the power converter can measure directly or indirectly the parameters that might be important for its operation.

In some examples, the controller 40 may further be configured to receive a DC link voltage and transmit the DC link voltage to the energy storage device 50. Again, the communication between the converter 30 and the energy storage device 50 may be carried out through the turbine controller 40. Since the DC link voltage may be continuously communicated to the energy storage device 50, e.g. through the controller 40, the energy storage device may be made aware of the suitable moment for connecting. In this particular example, the batteries may close the switch or switches 51 to electrically connect to the DC link.

The fact that communication or data transmission between the power converter 30 and the energy storage device 50 does not occur directly, but rather through the controller 40 of the renewable power source 1 also means that the energy storage device 50 will not be aware that communication is (temporarily) lost between the power converter 30 and the controller 40 of the renewable power source 1. Similarly, the power converter 30 is unaware that communication may have been temporarily lost between the energy storage device 50 and the renewable power source controller 40, in this case the wind turbine controller. If the wind turbine controller 40 does not receive a voltage level from the battery 50, it cannot transmit it further either. This could lead to a problem in the functioning of the power converter. In order to avoid such problems, the controller may further be configured to transmit a default voltage level to the power converter if no voltage level is received form the energy storage device. By transmitting a predetermined default voltage level, the DC link may still receive a sensible instruction of the voltage level to be achieved at the DC link. In some examples, the default voltage level may be the nominal (i.e. rated) voltage level of the DC link.

In this particular example, the converter 30 comprises a machine side rectifier 32, a grid side inverter 36 and the DC link 31. In a specific example, the renewable power generator may be a doubly fed induction generator. In other examples, the renewable power generator may be a permanent magnet generator.

The power converter may in some examples be a full converter.

In this particular example, the renewable power source (wind turbine) drives a wind generator. The machine side rectifier 32 is configured for converting the source power to converted DC power. The power converter 30 further comprises a DC link 31 for receiving the converted DC power, and a grid side inverter 36 coupled to the DC link 31 for converting DC link power from the DC link to AC output power for a grid. The control system 33 of the power converter may in operation balance the power produced with the grid demand, by controlling a state of charge of the energy storage device (a battery, a string of batteries, or multiple strings of batteries). The control system 33 of the power converter may receive reference signals from the wind turbine, the electrical grid and possible from a control at wind farm level and generate pulse width modulation (PWM) control signals for the source side and grid side converters 32 and 36.

In this particular example, the power converter control system 33 may be coupled to the control system 40 of the renewable power source. The power converter control system 33 may receive a voltage level of the energy storage device from the controller 40 of the renewable power source. The power converter control system 33 may also transmit a DC link voltage from the power converter 30 to the controller 40 of the renewable power source.

A power converter control system 33 may herein be understood as referring to a circuit or one or more processor(s) and associated memory device(s) configured to perform a variety of control functions as herein described of the power converter.

Machine side rectifier and grid side inverter 32 and 36 may each include a plurality of semiconductor switches 35, such as IGBTs (insulated gate bipolar transistors), IGCTs (insulated gate commutated thyristors), and MOSFETs (metal oxide semiconductor field effect transistors).

In this example, the energy storage device 50 may comprise an energy storage device control system 53 coupled to the controller 40 of the renewable power source. The energy storage device control system 53 may measure or determine the voltage level of the energy storage device. The energy storage device control system 53 may transmit the voltage level of the energy storage device to the controller 40. The controller may thus receive the voltage level of the energy storage device and transmit it to the power converter, e.g. through the power converter control system 33.

In some examples, the energy storage device control system may further control the storage or charge level of the energy storage device.

In the herein described example, the controller 40 of the renewable power source (i.e. wind turbine) may include one or more processor(s) and associated memory device(s) configured to perform a variety of computer-implemented functions (e.g., performing the methods, steps, calculations and the like and storing relevant data as disclosed herein) according to any of the methods herein described.

According to this aspect, the controller 40 may perform various different functions, such as receiving, transmitting and/or executing wind turbine control signals. In addition, the controller may also control the operation of the wind turbine. For example, the controller may be configured to control the blade pitch or pitch angle of each of the blades to control the power output generated by the wind turbine by adjusting an angular position of at least one blade relatively to the wind.

The controller 40 may also include a communications module to facilitate communications between the controller and the components of the wind turbine, and with the energy storage device and with the power converter. Further, the communications module may include a sensor interface (e.g., one or more analog-to-digital converters) to permit signals transmitted from one or more sensors to be converted into signals that can be understood and processed by the processors. It should be appreciated that the sensors may be communicatively coupled to the communications module using any suitable means as for example a wired connection or a wireless connection. As such, the processor may be configured to receive one or more signals from the sensors.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. The processor is also configured to compute advanced control algorithms and communicate to a variety of Ethernet or serial-based protocols (Modbus, OPC, CAN, etc.). Additionally, the memory device(s) may comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may be configured to store suitable computer-readable instructions that, when implemented by the processor(s), configure the controller to perform the various functions as described herein.

In accordance with the detailed example hereinbefore described, a method for connecting a DC link of a power converter with an energy storage device has been described.

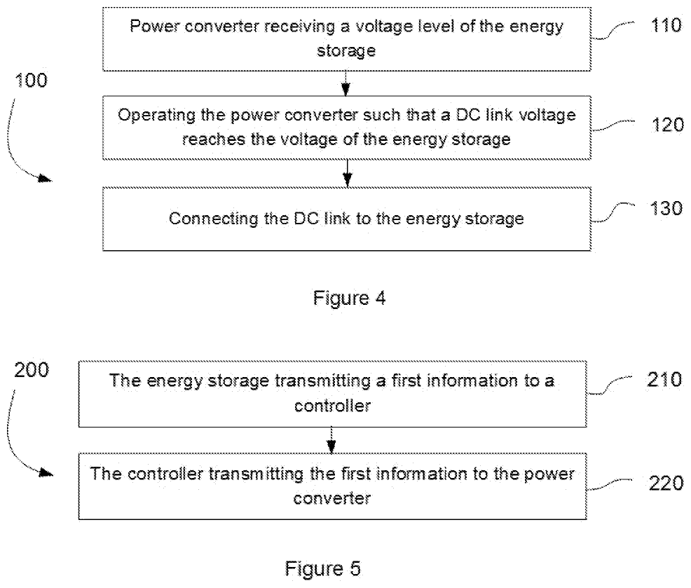

FIG. 4 is a flow diagram of a method 100 for connecting a DC link of a power converter with an energy storage device according to one example. The method 100 comprises the power converter receiving 110 a voltage level of the energy storage device from the energy storage device, and operating 120 the power converter such that a DC link voltage reaches the voltage level of the energy storage device. The method further comprises connecting 130 the DC link to the energy storage device when the DC link voltage substantially corresponds to the voltage level of the energy storage device.

However, receiving 110 the voltage level of the energy storage device comprises a controller of a renewable power source electrically coupled to the power converter receiving the voltage level of the energy storage device, and the controller transmitting this voltage level of the energy storage device to the power converter.

In some examples, a control system of the energy storage device may transmit the voltage level of the energy storage device to the controller of the renewable power source. In some other examples, a sensor coupled to the controller of the energy storage device may measure the voltage level of the energy storage device. The voltage level of the energy storage device may thus be received by the controller of the energy storage device.

In some examples, a controller of the converter may receive the voltage level of the energy storage device from the controller and/or transmit the voltage level of the DC link to the energy storage device, e.g. through the controller of the renewable power source.

In general, in accordance with the methods and systems herein described, a method has been provided for transmitting information between a power converter coupled to a generator of a turbine and an energy storage device.

FIG. 5 is a flow diagram of a method 200 for transmitting information between a power converter coupled to a generator of a turbine and an energy storage device according to one example. The method 200 comprises the energy storage device transmitting 210 a first information to a controller, and the controller of the turbine transmitting 220 the first information to the power converter. In this particular example, the first information may be a voltage level of the energy storage device. The first information may be a signal indicating the voltage level of the energy storage device. More particularly, this voltage level may be communicated when the energy storage device and the power converter are not electrically connected. In some examples, the first information may be transmitted to the controller of the turbine by the energy storage device, e.g. by an energy storage device control system.

In some examples, the energy storage device may have a first communication protocol, and the power converter has a second communication protocol, wherein the first and second communication protocols are incompatible. By using the turbine controller as man-in-the-middle communication may be provided in spite of the incompatibility.

In some other examples, direct communication between the energy storage device and the power converter may only temporarily have been interrupted. I.e. in principle direct communication is possible, but temporarily down due to a fault or technical problem. The turbine controller may thus temporarily take care of data transmission.

In some examples, the method may further comprise the power converter transmitting a second information to the controller of the turbine, and the controller of the turbine transmitting the second information to the energy storage device. Particularly, the second information may relate to a voltage level of a bus in the power converter, e.g. DC link, the bus configured to being connected to the energy storage device.

Throughout the present disclosure, specific reference has been made to (strings of) batteries to be used as energy storage device. Non-limiting alternative examples of types of electrical energy storage devices include super capacitors, motor-generator systems, and magnetic energy storage device systems.

Throughout the present disclosure, specific reference has been made to wind as a renewable energy, and to a wind turbine as a renewable power source. Non-limiting alternative examples of renewable power sources include sources such as photovoltaic modules, and marine hydrokinetic energy devices. In further examples, a hybrid power source based on e.g. a wind turbine and an array of solar panels could be used in combination with an energy storage device including e.g. a plurality of batteries. In such an example, the solar panels may be connected directly to the power converter of the wind turbine. MPPT tracking, monitoring and diagnostics of the solar panels may be managed by the power converter.

The type of power converter that is appropriate will depend somewhat upon the specific power source, with wind turbines and marine hydrokinetic energy devices tending to use AC to DC converters and photovoltaic power sources tending to use DC to DC converters as machine side converters. Grid side converter 36 will typically but not necessarily comprise a DC to AC inverter. The source and grid side converters 32 and 36 may comprise single phase or multi-phase configurations and may comprise single levels or multiple-levels.

The type of power converter used may also depend on the topology of the generator. For example, different generators may be used as wind turbine generators including e.g. permanent magnet generators, and doubly fed induction generators.

Grid or “electrical grid” as used herein is meant to include any interconnected network for delivering electricity from power sources to utility distribution systems and/or loads.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

Various aspects and embodiments of the present disclosure are defined by the following numbered clauses:

Clause 1. A system comprising:
a renewable power source with a renewable power generator and a controller for controlling the renewable power source,
a power converter electrically coupled with the renewable power generator and configured to connect the renewable power generator with an electrical grid, and the power converter comprising a DC link, and
an energy storage device configured to be electrically coupled with the DC link,
the controller is configured to receive a signal from the energy storage device and transmit the signal from the energy storage device to the power converter.

Clause 2. The system according to clause 1, wherein the renewable power source is a wind turbine and the renewable power generator is a wind turbine generator.

Clause 3. The system according to clauses 1 or 2, wherein the energy storage device comprises one or more batteries.

Clause 4. The system according to clause 3, wherein the batteries comprise one or more switches to electrically connect with the DC link.

Clause 5. The system according to any of claims 1-4, wherein the signal from the energy storage device comprises a voltage level of the energy storage device.

Clause 6. The system according to clause 5, wherein the controller is further configured to receive a DC link voltage and transmit the DC link voltage to the energy storage device.

Clause 7. The system according to any of clauses 1-6, wherein the renewable power generator is a doubly fed induction generator.

Clause 8. The system according to any of clauses 1-7, wherein the controller is further configured to transmit a default voltage level to the power converter if no voltage level is received form the energy storage device.

Clause 9. A method for connecting a DC link of a power converter with an energy storage device comprising:
the power converter receiving a voltage level of the energy storage device;
operating the power converter such that a DC link voltage reaches the voltage level of the energy storage device;
connecting the DC link to the energy storage device when the DC link voltage substantially corresponds to the voltage level of the energy storage device, wherein
receiving the voltage level of the energy storage device comprises
   a controller of a renewable power source electrically coupled to the power converter receiving the voltage level of the energy storage device, and
   the controller transmitting the voltage level of the energy storage device to the power converter.

Clause 10. The method according to clause 9, the method further comprising the controller receiving a DC link voltage from the power converter, and the controller transmitting the DC link voltage to the energy storage device.

Clause 11. The method according to clause 9 or 10, wherein the energy storage device comprises one or more batteries.

Clause 12. The method according to clause 11, wherein connecting the DC link to the batteries comprises the batteries closing a switch to electrically connect with the DC link.

Clause 13. The method according to any of clauses 9-12, further comprising the controller transmitting a predetermined voltage level to the converter if data communication between the energy storage device and the controller is lost.

Clause 14. The method according to clause 13, wherein the predetermined voltage level is a nominal voltage level of the energy storage device.

Clause 15. The method according to any of clauses 9-14, wherein the renewable power source is a wind turbine.

Clause 16. A method for transmitting information between a power converter coupled to a generator of a turbine and an energy storage device, comprising
the energy storage device transmitting a first information to a controller of the turbine, and
the controller of the turbine transmitting the first information to the power converter.

Clause 17. The method according to clause 16, wherein the energy storage device has a first communication protocol, the power converter has a second communication protocol, and the first and second communication protocols are incompatible.

Clause 18. The method according to clause 16, wherein direct communication between the energy storage device and the power converter is temporarily interrupted.

Clause 19. The method according to any of clauses 16-18, further comprising
the power converter transmitting a second information to the controller of the turbine, and
the controller of the turbine transmitting the second information to the energy storage device.

Clause 20. The method according to clause 19, wherein the first information relates to a voltage level of the energy storage device,
the second information relates to a voltage level of a bus in the power converter, the bus configured to being connected to the energy storage device.

1. A system comprising:
a renewable power source (1) with a renewable power generator and a controller (40) for controlling the renewable power source,
a power converter (30) electrically coupled with the renewable power generator and configured to connect the renewable power generator with an electrical grid, and the power converter comprising a DC link (31), and
an energy storage device (50) configured to be electrically coupled with the DC link, characterized in that
the controller (40) is configured to receive a signal from the energy storage device (50) and transmit the signal from the energy storage device (50) to the power converter (30).

2-15. (canceled)
